(19) United States
(12) Patent Application Publication
(10) Pub. No.: US 2010/0163812 A1
(43) Pub. Date: Jul. 1, 2010

(54) INK COMPOSITION FOR COLOR FILTER

(75) Inventors: Mi-Kyoung KIM, Daejeon (KR); Dae-Hyun KIM, Daejeon (KR)

Correspondence Address: ROTHWELL, FIGG, ERNST & MANBECK, P.C., 1425 K STREET, N.W., SUITE 800, WASHINGTON, DC, 20005, US

(73) Assignee: LG CHEM, LTD., Seoul (KR)

(21) Appl. No.: 12/646,567

(22) Filed: Dec. 23, 2009

(30) Foreign Application Priority Data
Dec. 24, 2008 (KR) 10-2008-0132753
Dec. 22, 2009 (KR) 10-2009-0128614

(51) Int. Cl. G02B 5/23; C08K 5/3492

(52) U.S. Cl. 252/586; 524/100

(57) ABSTRACT

An ink composition for a color filter is provided. The ink composition comprises a pigment, a binder resin, a polymerizable monomer and a melamine compound. The melamine compound has a weight average molecular weight of 126 to 5,000. The melamine compound is represented by Formula 1:

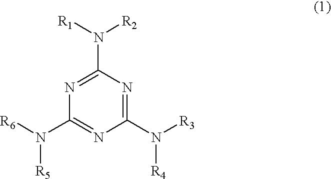

wherein R₁, R₂, R₃, R₄, R₅ and R₆ are each independently a hydrogen atom or a group including a C₁-C₆ alkyl group, a C₁-C₆ alkoxy group, a carboxyl group, a C₁-C₆ ether group, a C₁-C₆ alcohol group, an amino group, a nitro group, a hydroxyl group, a phenyl group or an acrylic group; a polymer thereof; or a mixture thereof. The use of the melamine compound in the ink composition prevents reduction of contrast ratio after high-temperature treatment and is effective in further improving the dispersibility of the ink. Further provided is a color filter produced by using the ink composition.

This application claims priority to and the benefit of Korean Patent Application Nos. 10-2008-0132753, filed on Dec. 24, 2008, and 10-2009-0128614, filed on Dec. 22, 2009, the entire disclosures of which are hereby incorporated by reference.

### BACKGROUND OF THE INVENTION

1. Field of the Invention

The present invention relates to an ink composition for a color filter and a color filter produced by using the ink composition.

2. Description of the Related Art

A typical liquid crystal display includes a first polarizer, a second polarizer and a liquid crystal layer interposed between the two polarizers. The first polarizer is operated so as to control the degree of polarization of light passing therethrough, and the second polarizer is operated so as to control the amount of light passing therethrough. A color filter is provided between the two polarizers to display colors. In recent years, liquid crystal displays have been widely used in monitors for televisions and personal computers. Under such circumstances, there is a need for high-brightness, high-contrast color filters.

A color filter has a structure in which two or more filter segments of different colors in the shape of very small stripes are arranged parallel to or crossing each other or small filter segments are arranged at regular intervals on the surface of a transparent substrate (e.g., glass). The filter segments are as small as several to several hundreds of micrometers and are regularly arranged at predetermined intervals for each color.

In a general color liquid crystal display, a transparent electrode for driving a liquid crystal is formed on a color filter by deposition or sputtering and an alignment layer is formed on the transparent electrode to align the liquid crystal molecules in a particular direction. The formation of the transparent electrode and the alignment layer requires thermal processing at high temperatures, typically at least 200° C. and preferably at least 230° C., to achieve sufficient performance characteristics. In view of this, pigment dispersion methods are usually used in the production of color filters. In the pigment dispersion methods, highly light and heat resistant pigments are used as colorants.

Generally, a color filter produced by using a dispersion of pigment has a problem in that the pigments cause light to scatter, which confuses the degree of polarization controlled by a liquid crystal. That is, light leakage occurs when light blocking is needed (“OFF” state) or transmitting light decays when light transmission is needed (“ON” state). Accordingly, the color filter suffers from the problem of low ratio of the brightness in the “ON” state to the brightness in the “OFF” state (i.e. a low contrast ratio) of a display.

A filter segment is formed using a coating solution for a color resist, which is prepared by blending a photopolymerization initiator and an ethylenically unsaturated monomer in a pigment dispersion. In an attempt to produce a high-brightness, high-contrast color filter, a method is known in which a pigment to be included in a filter segment is finely divided and is stably dispersed in a pigment carrier composed of a resin to prepare a pigment dispersion (see Japanese Unexamined Patent Publication No. Hei 10-130547).

Pigments are difficult to completely disperse owing to their strong tendency to aggregate. Thus, there is a need to finely divide the pigments. However, a color filter produced by using the finely divided pigments has a low brightness and a low contrast ratio. Further, the dispersion instability of a pigment dispersion causes aggregation of the pigment particles with the passage of time. This aggregation is responsible for high viscosity and poor flowability of the resulting coloring composition. Further, when the coloring composition is spin-coated on a glass substrate to form a filter segment, poor spin coatability and leveling are problematic, making it impossible to form a coating with uniform thickness.

Many efforts have been made to stabilize pigment dispersions containing finely divided pigments. For example, dispersion compositions using pigment derivatives or resinous dispersants have been optimized, and pigment derivatives, resinous dispersants and binder resins have been improved (see Japanese Unexamined Patent Publication No. 2005-181383). However, in some cases, there remains a difficulty in fully utilizing the performance of high-quality finely divided pigments.

When a high-contrast filter segment formed using a dispersion of a finely divided pigment is exposed to a temperature as high as 230° C. in the production steps of a color filter (for example, the steps of forming a transparent electrode and an alignment layer, and post baking), the dispersion system of the pigment is destroyed, resulting in a reduction in contrast ratio.

In pigment dispersion methods that are currently used in the production of color filters, highly light and heat resistant pigments are used as colorants. Pigments dispersed in a color filter cause scattering of light passing through two polarizers, resulting in a low contrast ratio. Particularly, large-sized pigment particles greatly increase the scattering of light, resulting in a low contrast ratio.

It is necessary to reduce the particle size of pigments in order to achieve a high contrast ratio. However, this size reduction increases the surface energy of the pigment particles, which is a cause of poor dispersion stability. The dispersion instability of the pigments causes the pigment particles to aggregate, leading to a low contrast ratio. A highly viscous or gelled ink composition may show jetting instability or may clog nozzles.

Pigment derivatives or resinous dispersants (or polymeric dispersants) are generally used to disperse finely divided pigments. Many patent applications regarding the use of pigment derivatives or resinous dispersants are currently being filed. In many cases, however, the use of pigment derivatives or dispersants is not sufficient to prevent finely divided pigments from aggregating or deterioration in dispersibility, which are phenomena occurring during high-temperature treatment (annealing at 200° C. or higher, for example, post baking) of ink containing a dispersion of the pigments. The deteriorated dispersibility of the pigments resulting from the high-temperature treatment brings about a low contrast ratio.

### SUMMARY OF THE INVENTION

In view of the foregoing and other problems of the prior art, an object of the present invention is to provide an ink composition for a color filter that has good heat resistance, high contrast and high flowability.

According to an aspect of the present invention, there is provided an ink composition for a color filter, comprising a pigment, a binder resin, a polymerizable monomer and a melamine compound wherein the melamine compound has a weight average molecular weight of 126 to 5,000 and is a compound represented by Formula 1:

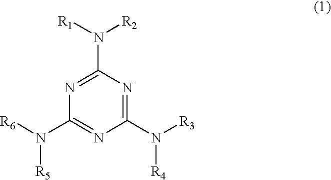

wherein R₁, R₂, R₃, R₄, R₅ and R₆ are each independently a hydrogen atom or a group including a C₁-C₆ alkyl group, a C₁-C₆ alkoxy group, a carboxyl group, a C₁-C₆ ether group, a C₁-C₆ alcohol group, an amino group, a nitro group, a hydroxyl group, a phenyl group or an acrylic group; a polymer (or an oligomer) thereof; or a mixture thereof.

In an embodiment, the compound of Formula 1 is represented by Formula 2:

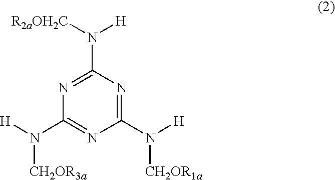

wherein R₁ₐ, R₂ₐ and R₃ₐ are each independently a hydrogen atom, a C₁-C₆ alkyl group or a (meth)acrylate group.

In another embodiment, the compound of Formula 1 is represented by Formula 3:

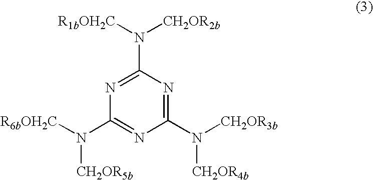

wherein R_{1b}, R_{2b}, R_{3b}, R_{4b}, R_{5b} and R_{6b} are each independently a hydrogen atom, a C₁-C₆ alkyl group or a (meth)acrylate group.

In another embodiment, the compound of Formula 1 is one of the compounds represented by Formulas 4 to 7:

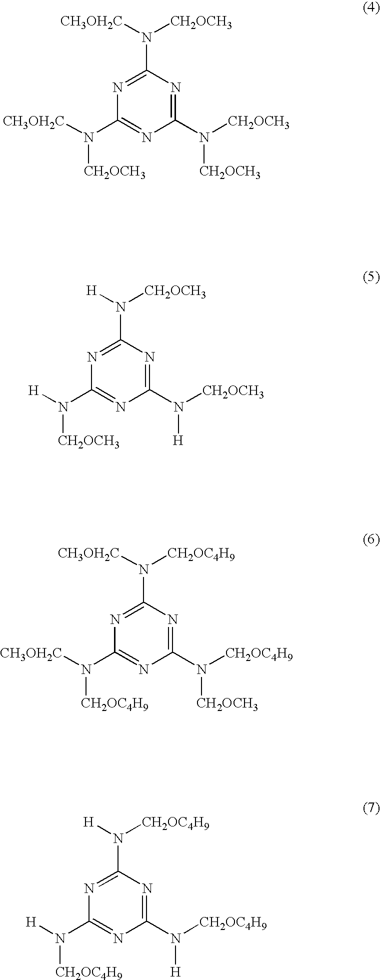

In an embodiment, the melamine compound is present in an amount of 1 to 20% by weight, based on the total weight of the composition.

In an embodiment, the ink composition further comprises a pigment dispersant; and the pigment, the pigment dispersant and the polymerizable monomer are present in amounts of 5 to 20% by weight, 1 to 10% by weight and 0.5 to 8% by weight, respectively, based on the total weight of the composition.

In an embodiment, the ink composition further comprises at least one additive.

In an embodiment, the ink composition has a viscosity of 10 to 18 cP.

According to another aspect of the present invention, there is provided a color filter produced by using the ink composition.

### DETAILED DESCRIPTION OF THE INVENTION

Exemplary embodiments of the present invention will now be described in detail.

The present invention provides an ink composition for a color filter, comprising a pigment, a binder resin, a polymerizable monomer and a melamine compound wherein the melamine compound has a weight average molecular weight of 126 to 5,000 and is a compound represented by Formula 1:

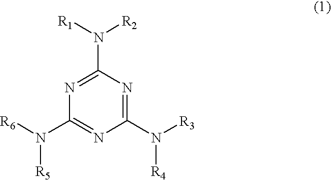

wherein R₁, R₂, R₃, R₄, R₅ and R₆ are each independently a hydrogen atom or a group including a C₁-C₆ alkyl group, a C₁-C₆ alkoxy group, a carboxyl group, a C₁-C₆ ether group, a C₁-C₆ alcohol group, an amino group, a nitro group, a hydroxyl group, a phenyl group or an acrylic group; a polymer (or an oligomer) thereof; or a mixture thereof.

The melamine compound of Formula 1 functions to improve the heat resistance of the ink. High-temperature treatment, such as post baking for forming an ink film or a subsequent processing step (e.g., the step of forming an alignment layer), impairs the dispersibility of the pigment, causing the pigment to aggregate. The melamine compound prevents the pigment from, aggregating during high-temperature treatment. Consequently, the melamine compound serves to prevent reduction in the contrast of a final color filter. Particularly, it is preferred that at least two of R₁, R₂, R₃, R₄, R₅ and R₆ in Formula 1 are other than hydrogen. The melamine compound having at least two substituents other than hydrogen is readily cross-linked with the other components, contributing to further improvement in the heat resistance of the ink composition and the dispersibility of the pigment. More preferably, at least three of R₁, R₂, R₃, R₄, R₅ and R₆ in Formula 1 are other than hydrogen.

The use of a melamine compound in an ink is effective in lowering the viscosity of the ink because the melamine compound is less viscous than a binder or a cross-linker commonly used in the art. The optimum viscosity of an ink composition for a color filter suitable for use in ink jetting is generally limited to the range of 10 to 18 cP. When a melamine compound is used in an ink instead of a cross-linker to cross-link a binder resin, the viscosity of the ink can be lowered, resulting in an increase in the solids content of the ink. That is, the solids content of an ink in the absence of a melamine compound is not increased due to the limited viscosity of the ink. In contrast, the use of a melamine compound in an ink provides a margin in the viscosity of the ink, leading to an increase by about 1% to about 2% in solids content. As the solids content of an ink for use in ink jetting increases, the number of drops of the ink necessary for filling a pixel decreases, which is advantageous in terms of processing efficiency (reduced difference in layer-thickness of the pixel and reduced tact time). In addition, the amount of materials used is reduced, which are economically advantageous.

Particularly preferably, the compound of Formula 1 is represented by Formula 2 or 3:

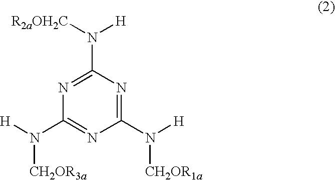

wherein R₁ₐ, R₂ₐ and R₃ₐ are each independently a hydrogen atom, a C₁-C₆ alkyl group or a (meth)acrylate group;

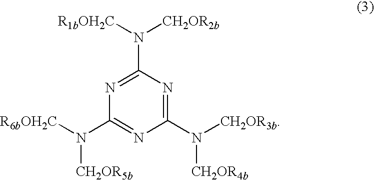

wherein R_{1b}, R_{2b}, R_{3b}, R_{4b}, R_{5b} and R_{6b} are each independently a hydrogen atom, a C₁-C₆ alkyl group or a (meth)acrylate group.

The melamine compound has a weight average molecular weight of 126 to 5,000. Within this range, the melamine compound is effective in preventing reduction of contrast ratio after high-temperature treatment, which will be described in Examples Section that follows. Particularly, if the weight average molecular weight of the melamine compound exceeds 5,000, the viscosity of the ink composition tends to increase, posing the risk that there may be difficulty in jetting the ink composition. The melamine compound preferably has a weight average molecular weight ranging from 200 to 4,000 and more preferably from 300 to 3,000.

The melamine compound is preferably present in an amount of 1 to 20% by weight, based on the total weight of the composition. The content of the melamine compound less than 1% by weight does not contribute to the prevention of reduction in contrast ratio after high-temperature treatment and does not significantly improve the dispersibility of the ink. Meanwhile, the content of the melamine compound more than 20% by weight is unfavorable because the contents of the other components (e.g., the pigment) are relatively low. Particularly, if the pigment content is too low, there is the risk that a desired color cannot be obtained at a given thickness.

The pigment may be a mixture of two or more kinds of organic or inorganic pigments. A highly color developable and heat resistant organic pigment is particularly preferred.

Specific examples of pigments suitable for use in the ink composition of the present invention include the following red, green, yellow, blue, violet, cyan and magenta pigments, which are represented by color index numbers.

As the red pigments, there can be used, for example, C. I. Pigment Red 7, 14, 41, 48:1, 48:2, 48:3, 48:4, 81:1, 81:2, 81:3, 81:4, 146, 168, 177; 178, 179, 184, 185, 187, 200, 202, 208, 210, 246, 254, 255, 264, 270, 272, 279. Of these, C. I. Pigment Red 177 and 254 are preferred from the standpoint of brightness and contrast.

As the green pigments, there can be used, for example, C. I. Pigment Green 7, 10, 36, 37, 58. Of these, C. I. Pigment Green 7, 36, 58 are preferred from the standpoint of brightness and contrast.

As the yellow pigments, there can be used, for example, C. I. Pigment Yellow 1, 2, 3, 4, 5, 6, 10, 12, 13, 14, 15, 16, 17, 18, 24, 31, 32, 34, 35, 35:1, 36, 36:1, 37, 37:1, 40, 42, 43, 53, 55, 6300•61, 62, 63, 65, 73, 74, 77, 81, 83, 93, 94, 95, 97, 98, 100, 101, 104, 106, 108, 109, 110, 113, 114, 115, 116, 117, 118, 119, 120, 123, 126, 127, 128, 129, 138, 139, 147, 150, 151, 152, 153, 154, 155, 156, 161, 162, 164, 166, 167, 168, 169, 170, 171, 172, 173, 174, 175, 176, 177, 179, 180, 181, 182, 185, 187, 188, 193, 194, 198, 199, 213, 214. Of these, C. I. Pigment Yellow 138, 139, 150 are preferred from the standpoint of brightness and contrast.

As the blue pigments, there can be used, for example, C. I. Pigment Blue 15, 15:1, 15:2, 15:3, 15:4, 15:6, 16, 22, 60, 64.

One example of the violet pigments is C. I. Violet 23.

As the cyan pigments, there can be used, for example, C. I. Pigment Blue 15:3 and a mixture of C. I. Pigment Blue 15:3 and C. I. Pigment Green 7.

As the magenta pigments, there can be used, for example, C. I. Pigment Red 81, 81:1, 81:2, 81:3, 81:4, 122, 192, 202, 207, 209 and C. I. Pigment Violet 19.

The composition of the present invention may further comprise at least one colorant other than the pigment. As the additional colorant, there can be exemplified a pigment or a natural colorant.

From the standpoint of achieving high contrast of the ink composition, it is preferred to finely divide the pigment. The pigment can be finely divided by suitable processes, for example, an abrasion process, a precipitation process and a synthetic precipitation process. According to the pulverization process, the pigment is mechanically ground. According to the precipitation process, a solution of the pigment in a good solvent is added to a poor solvent to precipitate the pigment in a finely divided form. According to the synthetic precipitation process, the pigment is prepared in a finely divided form at the stage of synthesis. A suitable process can be selected according to the synthesis method and chemical properties of the pigment used.

The pigment is preferably present in an amount of 5 to 20% by weight, based on the total weight of the composition.

The ink composition of the present invention may further comprise a pigment dispersant. The pigment dispersant is added to increase the dispersibility of the pigment and to prevent the pigment from reaggregating after dispersion.

The pigment dispersant is preferably a polymer having acid or base groups as anchors. The pigment dispersant is adsorbed to the surface of the pigment via the acid or base groups. The repulsive forces effectively act between the adjacent polymer molecules to maintain the dispersion stability of the pigment.

Sulfonyl groups and amino groups are preferred as the acid groups and the base groups, respectively, due to their high adsorptivity.

The dispersant having acid or base groups is preferably a comb polymer having a structure in which branch polymers are grafted onto a stem polymer having the acid or base groups. The strong sterically repulsive forces between the branch polymers render the dispersant more soluble in an organic solvent. Preferably, the comb polymer has a molecular structure in which two or more branch polymer molecules are grafted onto one stem polymer molecule.

Examples of resinous pigment dispersants suitable for use in the present invention include: Disperbyk-101, 103, 107, 108, 110, 111, 116, 130, 140, 154, 161, 162, 163, 164, 165, 166, 170, 171, 174, 180, 181, 182, 183, 184, 185, 190, 2000, 2001, Anti-Terra-U, 203, 204, BYK-P104, P104S, 220S, Lactimon, Lactimon-WS and Bykumen, all of which are commercially available from BYK Chemie; SOLSPERSE-3000, 9000, 13240, 13650, 13940, 17000, 18000, 20000, 21000, 24000, 26000, 27000, 28000, 31845, 32000, 32500, 32600, 34750, 36600, 38500, 41000, 41090, 53095, all of which are commercially available from Nippon Lubrizol; and EFKA-46, 47, 48, 452, LP4008, 4009, LP4010, LP4050, LP4055, 400, 401, 402, 403, 450, 451, 453, 4540, 4550, LP4560, 120, 150, 1501, 1502, 1503, all of which are commercially available from EFKA Chemicals.

The pigment dispersant is preferably present in an amount of 1 to 10% by weight, based on the total weight of the composition.

The binder resin may be any of those commonly used in the art.

The binder resin is preferably present in an amount of 8% by weight or less, based on the total weight of the composition.

The ink composition of the present invention may further comprise a thermal initiator to initiate the thermal polymerization of the polymerizable monomer. Specific example of thermal initiators suitable for use in the present invention include, but are not limited to, 2,2′-azobisisobutyronitrile (AIBN), 2,2′-azobis-(2,4-dimethylvaleronitrile), 2,2′-azobis-(4-methoxy-2,4-dimethylvaleronitrile), 2-cyano-2-propylazoformamide, 1,1′-azobis(cyclohexane-1-carbonitrile), 2,2′-azobis(2-methylbutyronitrile), V-40, VA-086, VA-085, VF096, VAm-110, Vam-111, all of which are commercially available from Wako Pure Chemicals Ind., benzoyl peroxide, lauroyl peroxide, t-butyl peroxypivalate, and 1,1′-bis-(bis-t-butylperoxy)cyclohexane. These thermal initiators may be used alone or as a mixture of two or more thereof.

The thermal initiator is preferably present in an amount of 1.5% by weight or less, based on the total weight of the composition.

The polymerizable monomer may be any of those commonly used in the art. As the polymerizable monomer, there can be exemplified an ethylenically unsaturated monomer having at least one carboxyl group. Examples of such polymerizable monomers include: acrylic acid esters and methacrylic acid esters, such as methyl (meth)acrylate, ethyl (meth)acrylate, 2-hydroxyethyl (meth)acrylate, 2-hydroxypropyl (meth)acrylate, cyclohexyl (meth)acrylate, β-carboxyethyl (meth)acrylate, polyethylene glycol di(meth)acrylate, 1,6-hexanediol di(meth)acrylate, triethylene glycol di(meth)acrylate, tripropylene glycol di(meth)acrylate, trimethylolpropane tri(meth)acrylate, pentaerythritol tri(meth)acrylate, 1,6-hexanediol diglycidyl ether di(meth)acrylate, bisphenol A diglycidyl ether di(meth)acrylate, neopentyl glycol diglycidyl ether di(meth)acrylate, dipentaerythritol hexa(meth)acrylate, tricyclodecanyl (meth)acrylate, ester acrylate, (meth)acrylic acid ester of methylolated melamine, epoxy (meth)acrylate and urethane acrylate; (meth)acrylic acid; styrene; vinyl acetate; ethers, such as hydroxyethyl vinyl ether, ethylene glycol divinyl ether and pentaerythritol trivinyl ether; (meth)acrylamide; N-hydroxymethyl (meth)acrylamide; N-vinyl formamide; and acrylonitrile. These polymerizable monomers may be used alone or as a mixture of two or more thereof.

The polymerizable monomer is preferably present in an amount of 0.5 to 8% by weight, based on the total weight of the composition. If the content of the polymerizable monomer is less than 0.5% by weight, sufficient cross-linking does not occur after pattern formation of the ink. This insufficient cross-linking decreases the degree of cure of the ink, making it impossible to obtain desired film strength and chemical resistance. Meanwhile, if the content of the polymerizable monomer exceeds 8% by weight, the ink may be highly viscous and poorly flowable.

The ink composition of the present invention may further comprise an organic solvent. The organic solvent plays a role in sufficiently dispersing the colorant in the transparent resin. Another role of the organic solvent is to facilitate jetting of the ink composition on a transparent substrate (e.g., glass) having a patterned black matrix (BM) thereon. The jetting is performed until a 0.2 to 5 μm thick dry film is formed. That is, the organic solvent makes it easy for the ink composition to form a filter segment by jetting.

Examples of the organic solvent include cyclohexanone, ethyl cellosolve acetate, butyl cellosolve acetate, propylene glycol monomethyl ether acetate, diethylene glycol dimethyl ether, ethylbenzene, ethylene glycol diethyl ether, xylene, ethyl cellosolve, methyl-n-amyl ketone, propylene glycol monomethyl ether, toluene, methyl ethyl ketone, ethyl acetate, methanol, ethanol, isopropyl alcohol, butanol, isobutyl ketone, and petroleum solvents. These solvents may be used alone or as a mixture thereof.

The organic solvent preferably has a boiling point of 180 to 300° C. and a vapor pressure at room temperature of about 0.5 mmHg. The organic solvent having a boiling point of at least 180° C. plays a role in preventing a nozzle from drying out to facilitate jetting (discharge) of the ink. Non-limiting examples of the organic solvent include ethylene glycol monobutyl ether acetate, diethylene glycol monobutyl ether acetate, and diethylene glycol monoethyl ether acetate. These organic solvents may be used alone or as a mixture thereof.

The ink composition of the present invention may further comprise at least one additive selected from a dispersion aid, a storage stabilizer, a curing accelerator, a thermal polymerization inhibitor, a plasticizer, an adhesion promoter, a filler, a defoaming agent and an anticoagulant.

The dispersion aid may be a surfactant. The dispersion aid is very effective in dispersing the colorant and preventing the colorant from reaggregating after dispersion. Since the colorant is dispersed in the transparent resin with the aid of the dispersion aid, the use of the ink composition enables the production of a highly transparent color filter. Examples of the surfactant include: anionic surfactants, such as polyoxyethylene alkyl ether sulfate, sodium dodecylbenzenesulfonate, an alkali salt of a styrene-acrylic acid copolymer, sodium alkylnaphthalenesulfonate, sodium alkyl diphenyl ether disulfonate, monoethanolamine lauryl sulfate, triethanolamine lauryl sulfate, ammonium lauryl sulfate, monoethanolamine stearate, sodium stearate, sodium lauryl sulfate, and monoethanolamine of a styrene-acrylic acid copolymer; nonionic surfactants, such as polyoxyethylene oleyl ether, polyoxyethylene lauryl ether, polyoxyethylene nonyl phenyl ether, polyoxyethylene sorbitan monostearate, and polyethylene glycol monolaurate; cationic surfactants, such as alkyl quaternary ammonium salts and ethylene oxide adducts thereof; and amphoteric surfactants, such as alkyl betaines (e.g., alkyldimethylaminoacetic acid betaine) and alkyl imidazoline. These surfactants may be used alone or as a mixture of two or more thereof.

The storage stabilizer serves to stabilize the viscosity of the ink composition over a long period of time. Examples of the stabilizer include: quaternary ammonium chlorides; organic acids, such as lactic acid and oxalic acid, and methyl ethers thereof; t-butyl pyrocatechol; organic phosphines, such as tetraethyl phosphine and tetraphenyl phosphine; and phosphite salts.

The curing accelerator, the thermal polymerization inhibitor, the plasticizer, the adhesion promoter, the filler, the defoaming agent and the anticoagulant may be any of those used in the art.

The additive is added in an amount of 0.01 to 3% by weight, based on the total weight of the composition.

The viscosity of the ink composition is preferably from 10 to 18 cP and more preferably from 12 to 16 cP. Within this range, the ink composition can be most easily jetted.

The components of the ink composition according to the present invention can be added in any order. For example, the pigment, the pigment dispersant and the melamine compound and organic solvent are mixed together, and then the binder resin, the polymerizable monomer, the thermal initiator and the organic solvent are added thereto.

The present invention also provides a color filter produced by using the ink composition.

Specifically, the color filter of the present invention comprises a plurality of filter segments of two to six different colors selected from red, green, blue, magenta, cyan and yellow colors. At least one of the filter segments is formed using the ink composition of the present invention.

The color filter can be produced by ink jetting the ink composition on a substrate to form filter segments of different colors.

The substrate is made of glass having high visible transmission. The substrate may also be made of a resin, such as polycarbonate, polymethacrylic acid methyl ester or polyethylene terephthalate.

A black matrix (BM) layer can be formed by photolithography, for example, in accordance with the following procedure. The black matrix is a solvent- or alkali-developable black resist, which is cured by light irradiation. First, different photosensitive coloring compositions are applied to a transparent substrate by a suitable coating process, such as spray coating, spin coating, slit coating or roll coating, until a 0.2-5 μm thick dry film is formed. The coating is dried by prebaking at 60-120° C. for 0.5-5 min. The pre-baked coating is exposed to UV light through a mask having a predetermined pattern. The patterned mask may be disposed in contact with or spaced from the film. Thereafter, the exposed coating is dipped in a solvent or an alkaline developing solution or is sprayed with a developing solution to remove the unexposed portion, leaving a desired pattern only. Then, post baking is performed at 200-230° C. for 30-60 min to completely cure the BM portion. This photolithography ensures high precision of the BM portion.

An aqueous solution of sodium carbonate or sodium hydroxide is used as the alkaline developing solution. An organic alkali, such as dimethylbenzylamine or triethanolamine, may also be used. A defoaming agent or a surfactant may be added to the developing solution.

If necessary, the following procedure can be carried out to achieve higher exposure sensitivity to UV light. After the black resist is applied and dried, a water- or alkali-soluble resin (e.g., a polyvinyl alcohol or a water-soluble acrylic resin) is applied thereto and dried. A film capable of preventing the inhibition of polymerization by oxygen is formed on the dry coating, followed by UV exposure.

R, G and B color portions are formed on the BM patterned glass by ink jetting. Specifically, after R, G and B colors are jetted one by one to fill respective banks, prebaking (90° C., 3 min) and post baking (220° C., 30 min) are performed for each color jetting. Alternatively, R, G and B can be jetted simultaneously, followed by prebaking and post baking. The latter process is more preferable in terms of processing efficiency. Hereinafter, the present invention will be explained in more detail with reference to the following examples. However, these examples are given for illustrative purposes only and are not intended to limit the scope of the invention.

### EXAMPLES

### Example 1

3.5 Parts by weight of C. I. Pigment Red 254 as a red pigment, 6.2 parts by weight of C. I. Pigment Red 177 as another red pigment, 5.4 parts by weight of a pigment dispersant and 5.5 parts by weight of Cymel 303 (a mixture of the compound of Formula 4 and its polymer) as a melamine compound and 56.2 parts by weight of BCA were mixed together to prepare a pigment dispersion. The pigment dispersion was mixed with 0.9 parts by weight of a copolymer of benzyl (meth)acrylate/methyl (meth)acrylate/glycidyl (meth)acrylate as a binder resin, 2.0 parts by weight of dipentaerythritol hexa(meth)acrylate (DPHA) as a polymerizable monomer, 0.5 parts by weight of a thermal initiator (V-40) and 18.8 parts by weight of butyl carbitol acetate (BCA) as a solvent to prepare an ink for ink jetting. The parts by weight of all the components are based on 100 parts by weight of the ink composition.

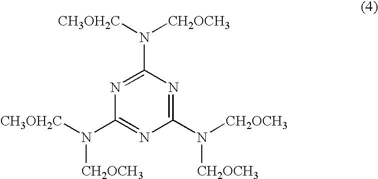

### Example 2

10.2 Parts by weight of C. I. Pigment Red 254 as a red pigment, 5.3 parts by weight of a pigment dispersant and 7.2 parts by weight of Cymel 303 (a mixture of the compound of Formula 4 and its polymer) as a melamine compound were mixed together to prepare a pigment dispersion. The pigment dispersion was mixed with 0.3 parts by weight of a copolymer of benzyl (meth)acrylate/methyl (meth)acrylate/glycidyl (meth)acrylate as a binder resin, 0.9 parts by weight of DPHA as a polymerizable monomer, 0.1 parts by weight of a thermal initiator (V-40) and 76 parts by weight of BCA as a solvent to prepare an ink. The parts by weight of all the components are based on 100 parts by weight of the ink composition.

### Example 3

10.2 Parts by weight of C. I. Pigment Red 177 as a red pigment, 5.4 parts by weight of a pigment dispersant and 7.1 parts by weight of Cymel 303 (a mixture of the compound of Formula 4 and its polymer) as a melamine compound were mixed together to prepare a pigment dispersion. The pigment dispersion was mixed with 0.3 parts by weight of a copolymer of benzyl (meth)acrylate/methyl (meth)acrylate/glycidyl (meth)acrylate as a binder resin, 0.9 parts by weight of DPHA as a polymerizable monomer, 0.1 parts by weight of a thermal initiator (V-40) and 76 parts by weight of BCA as a solvent to prepare an ink. The parts by weight of all the components are based on 100 parts by weight of the ink composition.

### Example 4

An ink for ink jetting was prepared in the same manner as in Example 1, except that Cymel 327 (a mixture of the compound of Formula 5 and its polymer) was used as a melamine compound.

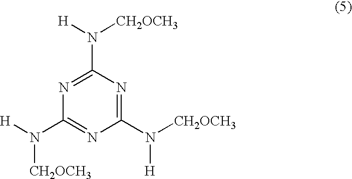

### Example 5

An ink for ink jetting was prepared in the same manner as in Example 1, except that Cymel 1130 (a mixture of the compound of Formula 6 and its polymer) was used as a melamine compound.

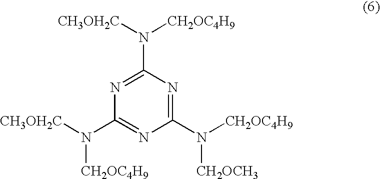

### Example 6

An ink for ink jetting was prepared in the same manner as in Example 1, except that Cymel 1158 (a mixture of the compound of Formula 7 and its polymer) was used as a melamine compound.

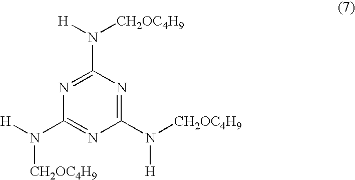

### Comparative Example 1

3.5 Parts by weight of C. I. Pigment Red 254 as a red pigment, 6.2 parts by weight of C. I. Pigment Red 177 as another red pigment and 5.4 parts by weight of a pigment dispersant and 56.2 parts by weight of BCA were mixed together to prepare a pigment dispersion. The pigment dispersion was mixed with 2.7 parts by weight of a copolymer of benzyl (meth)acrylate/methyl (meth)acrylate/glycidyl (meth)acrylate as a binder resin, 5.7 parts by weight of DPHA as a polymerizable monomer, 0.5 parts by weight of a thermal initiator (V-40) and 18.8 parts by weight of BCA as a solvent to prepare an ink for ink jetting. The parts by weight of all the components are based on 100 parts by weight of the ink composition.

### Comparative Example 2

10.2 Parts by weight of C. I. Pigment Red 254 as a red pigment and 5.3 parts by weight of a pigment dispersant and 56.2 parts by weight of BCA were mixed together to prepare a pigment dispersion. The pigment dispersion was mixed with 2.7 parts by weight of a copolymer of benzyl (meth)acrylate/methyl (meth)acrylate/glycidyl (meth)acrylate as a binder resin, 5.7 parts by weight of DPHA as a polymerizable monomer, 0.1 parts by weight of a thermal initiator (V-40) and 18.8 parts by weight of BCA as a solvent to prepare an ink. The parts by weight of all the components are based on 100 parts by weight of the ink composition.

### Comparative Example 3

10.2 Parts by weight of C. I. Pigment Red 177 as a red pigment and 5.4 parts by weight of a pigment dispersant were mixed together to prepare a pigment dispersion. The pigment dispersion was mixed with 2.6 parts by weight of a copolymer of benzyl (meth)acrylate/methyl (meth)acrylate/glycidyl (meth)acrylate as a binder resin, 5.7 parts by weight of DPHA as a polymerizable monomer, 0.1 parts by weight of a thermal initiator (V-40) and 76 parts by weight of BCA as a solvent to prepare an ink. The parts by weight of all the components are based on 100 parts by weight of the ink composition.

### Experimental Example 1

The inks of Examples 1-6 and Comparative Examples 1-3 were measured for contrast ratio as follows.

Contrast Ratio Measurement

Each of the inks was applied to clean glass. The coated glass was prebaked at 90° C. for 3 min and post-baked at 220° C. for 30 min to completely cure the ink. The ink coating was measured to have a thickness of 1-2 μm. The contrast ratios of the pre-baked sample and the post-baked sample were measured. The results are shown in Tables 1 and 2.

TABLE 1

| | | Contrast ratio | Contrast ratio | Viscosity |
|---|---|---|---|---|
| | Ink composition | after prebaking | after post baking | (cP) |
| Example 1 | Red pigments (R254, R177), | 6,234 | 5,798 | 12.8 |
| | melamine compound (Cymel 303) | | | |
| Example 2 | Red pigment (R254), | 4,088 | 3,553 | 15.6 |
| | melamine compound (Cymel 303) | | | |
| Example 3 | Red pigment (R177), | 7,454 | 7,553 | 12.7 |
| | melamine compound (Cymel 303) | | | |
| Comparative | Melamine compound was not | 6,051 | 5,317 | 16.3 |
| Example 1 | added in Example 1 | | | |
| Comparative | Melamine compound was not | 4,053 | 3,313 | 16.2 |
| Example 2 | added in Example 2 | | | |
| Comparative | Melamine compound was not | 6,908 | 6,691 | 13.8 |
| Example 3 | added in Example 3 | | | |

* Contrast ratio = Brightness value when upper and lower polarizers were parallel to each other/Brightness value when upper and lower polarizers were perpendicular to each other

TABLE 2

| | | Weight average | Contrast | |
|---|---|---|---|---|
| | | molecular weight of | ratio after | Viscosity |
| | Ink composition | melamine compound | post baking | (cP) |
| Example 1 | Red pigments (R254, R177), | 585 | 5,798 | 12.8 |
| | melamine compound (Cymel 303) | | | |
| Example 4 | Red pigments (R254, R177), | 509 | 6,022 | 14.5 |
| | melamine compound (Cymel 327) | | | |
| Example 5 | Red pigments (R254, R177), | 1,137 | 5,707 | 13.8 |
| | melamine compound (Cymel 1130) | | | |
| Example 6 | Red pigments (R254, R177), | 2,881 | 5,522 | 12.6 |
| | melamine compound (Cymel 1158) | | | |

* Contrast ratio = Brightness value when upper and lower polarizers were parallel to each other/Brightness value when upper and lower polarizers were perpendicular to each other
* Measurement of molecular weight of the melamine compounds

The molecular weights of the melamine compounds used in Examples 1, 4, 5 and 6 were determined on a polystyrene basis by gel permeation chromatography (GPC) using tetrahydrofuran as a solvent. The results are shown in Table 3.

TABLE 3

| | Partial integral values | Total integral value |
|---|---|---|
| Cymel 303 | 1,295/583/293 | 585 |
| Cymel 327 | 1,115/601/311 | 509 |
| Cymel 1130 | 2,060/789/416 | 1,137 |
| Cymel 1158 | 4,083/952/548 | 2,881 |

As can be seen from the results in Table 1, the ink compositions of Examples 1-6, each of which comprises the corresponding melamine compound, had higher contrast ratios. Particularly, the ink compositions of Examples 1-6 were very effective in preventing reduction of contrast ratio after the post baking. Generally, post baking tends to decrease the contrast ratio of ink compositions. The differences in the contrast ratio of the ink compositions of Example 1 and Comparative Example 1 before and after the post baking were about 430 and about 730, respectively. That is, the contrast ratio of the ink composition of Example 1 was less reduced by the post baking.

Further, the results in Table 2 show that the ink compositions of Examples 1, 4, 5 and 6 had slightly different contrast ratios according to the weight average molecular weights of the melamine compounds. Particularly, the melamine compound having a weight average molecular weight of about 500 was more advantageous in improving the contrast ratio of the ink composition.

As is apparent from the foregoing, the use of the melamine compound in the ink composition of the present invention prevents reduction of contrast ratio after high-temperature treatment and is effective in further improving the dispersibility of the ink. In addition, the melamine compound is effective in lowering the viscosity of the ink. Therefore, the solids content of the ink increases when the melamine compound is used rather than when the melamine compound is not used.

What is claimed is:

1. An ink composition for a color filter, comprising a pigment, a binder resin, a polymerizable monomer and a melamine compound, wherein the melamine compound has a weight average molecular weight of 126 to 5,000 and is represented by Formula 1: 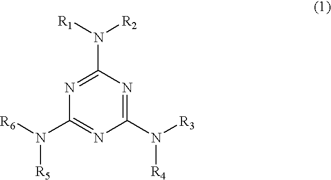
wherein R₁, R₂, R₃, R₄, R₅ and R₆ are each independently a hydrogen atom or a group including a C₁-C₆ alkyl group, a C₁-C₆ alkoxy group, a carboxyl group, a C₁-C₆ ether group, a C₁-C₆ alcohol group, an amino group, a nitro group, a hydroxyl group, a phenyl group or an acrylic group; a polymer thereof; or a mixture thereof.

2. The ink composition of claim 1, wherein the melamine compound is represented by Formula 2: 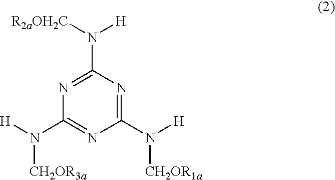
wherein R₁ₐ, R₂ₐ and R₃ₐ are each independently a hydrogen atom, a C₁-C₆ alkyl group or a (meth)acrylate group.

3. The ink composition of claim 1, wherein the melamine compound is represented by Formula 3: 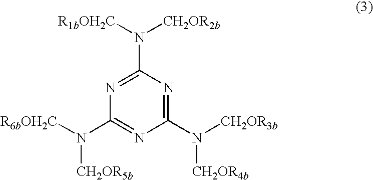
wherein R_{1b}, R_{2b}, R_{3b}, R_{1b}, R_{5b} and R_{6b} are each independently a hydrogen atom, a C₁-C₆ alkyl group or a (meth)acrylate group.

4. The ink composition of claim 1, wherein the melamine compound is one of the compounds represented by Formulas 4 to 7:

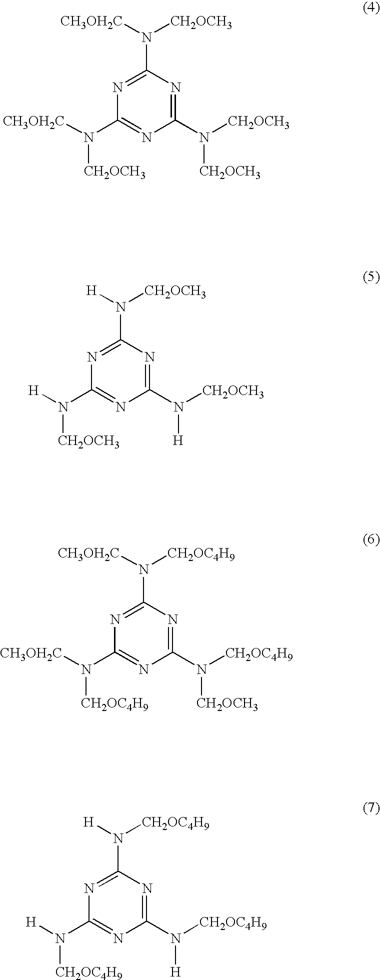

5. The ink composition of claim 1, wherein the melamine compound is present in an amount of 1 to 20% by weight, based on the total weight of the composition.

6. The ink composition of claim 5, further comprising a pigment dispersant; and wherein the pigment, the pigment dispersant and the polymerizable monomer are present in amounts of 5 to 20% by weight, 1 to 10% by weight and 0.5 to 8% by weight, respectively, based on the total weight of the composition.

7. The ink composition of claim 6, wherein the pigment dispersant is a polymer having an acid or base group as an anchor.

8. The ink composition of claim 7, wherein the acid group is a sulfonyl group and the base group is an amino group.

9. The ink composition of claim 1, comprising the binder resin in an amount of not more than 8% by weight, based on the total weight of the composition.

10. The ink composition of claim 1, further comprising a thermal initiator.

11. The ink composition of claim 10, wherein the thermal initiator is present in an amount of 1.5% by weight or less, based on the total weight of the composition.

12. The ink composition of claim 1, wherein the polymerizable monomer is at least one selected from the group consisting of acrylic acid esters and methacrylic acid esters, such as methyl (meth)acrylate, ethyl (meth)acrylate, 2-hydroxyethyl (meth)acrylate, 2-hydroxypropyl (meth)acrylate, cyclohexyl (meth)acrylate, β-carboxyethyl(meth)acrylate, polyethylene glycol di(meth)acrylate, 1,6-hexanediol di(meth)acrylate, triethylene glycol di(meth)acrylate, tripropylene glycol di(meth)acrylate, trimethylolpropane tri(meth)acrylate, pentaerythritol tri(meth)acrylate, 1,6-hexanediol diglycidyl ether di(meth)acrylate, bisphenol A diglycidyl ether di(meth)acrylate, neopentyl glycol diglycidyl ether di(meth)acrylate, dipentaerythritol hexa(meth)acrylate, tricyclodecanyl (meth)acrylate, ester acrylate, (meth)acrylic acid ester of methylolated melamine, epoxy (meth)acrylate and urethane acrylate; (meth)acrylic acid; styrene; vinyl acetate; ethers, such as hydroxyethyl vinyl ether, ethylene glycol divinyl ether and pentaerythritol trivinyl ether; (meth)acrylamide; N-hydroxymethyl (meth)acrylamide; N-vinyl formamide; and acrylonitrile

13. The ink composition of claim 1, further comprising an organic solvent.

14. The ink composition of claim 1, further comprising at least one additive.

15. The ink composition of claim 14, wherein the additive is at least one selected from the group consisting of a dispersion aid, a storage stabilizer, a curing accelerator, a thermal polymerization inhibitor, a plasticizer, an adhesion promoter, a filer, a defoaming agent and an anticoagulant.

16. The ink composition of claim 1, wherein the ink composition has a viscosity of 10 to 18 cP.

17. A color filter produced by using the ink composition of claim 1.
